(19) United States
(12) Patent Application Publication
(10) Pub. No.: US 2025/0210905 A1
(43) Pub. Date: Jun. 26, 2025

(54) CONNECTOR

(71) Applicants: TOYOTA JIDOSHA KABUSHIKI KAISHA, Toyota-shi (JP); SUMITOMO WIRING SYSTEMS, LTD., Yokkaichi (JP)

(72) Inventors: Toshiki NUNOTANI, Toyota-shi (JP); Tomohiro IMAO, Toyota-shi (JP); Akihisa OGAWA, Suzuka-shi (JP); Takashi NOBUKUNI, Yokkaichi-shi (JP)

(73) Assignees: TOYOTA JIDOSHA KABUSHIKI KAISHA, Toyota-shi (JP); SUMITOMO WIRING SYSTEMS, LTD., Yokkaichi (JP)

(21) Appl. No.: 18/950,954

(22) Filed: Nov. 18, 2024

(30) Foreign Application Priority Data
Dec. 26, 2023 (JP) 2023-219027

(51) Int. Cl. H01R 13/502

(52) U.S. Cl. CPC H01R 13/502

(57) ABSTRACT

A connector that is allowed to be fitted to a mating connector including a housing configured to be fitted to the mating connector through insertion of a front surface of the housing into an opening portion of the mating connector, and a rectangular and tabular front mask that has a hole through which a terminal of the mating connector is inserted, and is attached to the front surface of the housing, wherein the plate thicknesses at both end portions of the front mask on short sides of the rectangle are larger than the plate thickness at a center portion of the front mask.

### CROSS-REFERENCE TO RELATED APPLICATION

This application claims priority to Japanese Patent Application No. 2023-219027 filed on Dec. 26, 2023, incorporated herein by reference in its entirety.

### BACKGROUND

### 1. Technical Field

The disclosure relates to the structure of a connector having a front mask.

### 2. Description of Related Art

Japanese Unexamined Patent Application Publication No. 2011-003299 discloses a connector (female connector) that can be fitted to a mating connector (male connector) having a rib in a front-rear direction. JP 2011-003299 A describes a connector having a structure that includes a housing that has a recess portion for receiving a rib and is opened at a front surface thereof, a front mask that is a front member attached to the front surface of the housing, a hook portion that is provided on the front mask so as to correspond to the position of the recess portion, and a restricting portion that is provided on the recess portion to restrict the front-rear movement of the front mask by engaging with the hook portion.

### SUMMARY

It is conceivable that the connector described in JP 2011-003299 A is used as a connector for a wire harness (W/H) for a vehicle. In a manufacturing process of wire harnesses or an assembly process of vehicles, an external force may be applied to the connector from electric wires. When an external force is applied to the connector from an electric wire, the structure of the connector described in JP 2011-003299 A has a risk that a force for pushing out the front mask of the connector is caused by terminals of the mating connector, and when the rigidity is insufficient, the front mask may deform or float from the housing. The positional displacement caused by the deformation or floating of the front mask causes a gap between the front mask and the housing, which induces a risk that foreign matter enters through the gap.

The disclosure has been made in consideration of the above-mentioned problems, and has an object to provide a connector that can restrain positional displacement of a front mask after terminals of a mating connector are inserted.

In order to solve the above problems, an aspect of a technique of the disclosure is a connector that is allowed to be fitted to a mating connector, the connector including a housing and a rectangular and tabular front mask. The housing is configured to be fitted to the mating connector through insertion of a front surface of the housing into an opening portion of the mating connector. The front mask has a hole through which a terminal of the mating connector is inserted, and is attached to the front surface of the housing. Plate thicknesses at both end portions of the front mask on short sides of the rectangle are larger than a plate thickness at a center portion of the front mask.

According to the connector of the disclosure, the thicknesses of both end portions of the front mask may be increased to enhance rigidity, so that it is possible to restrain the positional displacement of the front mask after the terminal of the mating connector is inserted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a front mask constituting a connector according to an embodiment of the disclosure;

FIG. 2 is a view of the front mask in FIG. 1 which is taken along a direction indicated by an arrow A;

FIG. 3 is a perspective view of a housing constituting the connector according to the embodiment of the disclosure;

FIG. 4 is a view of the housing in FIG. 3 which is taken along a direction indicated by an arrow B;

FIG. 5 is an enlarged perspective view of a portion C of the housing in FIG. 4;

FIG. 6 is a perspective view of the connector in which the front mask is fitted to the housing;

FIG. 7 is a view of the connector in FIG. 6 which is taken along a direction indicated by an arrow D;

FIG. 8 is a perspective view of a connector having a conventional structure; and

FIG. 9 is a view of the connector having the conventional structure in FIG. 8 which is taken along a direction indicated by an arrow E.

### DETAILED DESCRIPTION OF EMBODIMENTS

The connector according to the disclosure is molded such that the thickness of the front mask to be attached to the front surface of the housing is larger at both the end portions of the front mask than that at the center portion of the front mask. This enhances the rigidity of the front mask, so that the front mask can be restrained from being positionally displaced due to an external force applied to the connector.

An embodiment of the disclosure will be described in detail below with reference to the drawings.

### Embodiment

### Shapes of Components

### (1) Front Mask

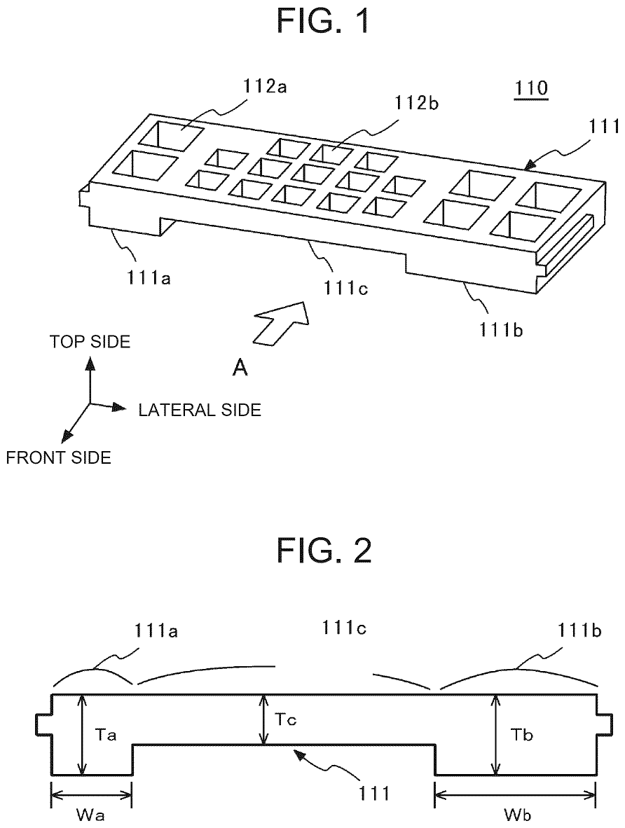

FIG. 1 is a perspective view of a front mask 110 constituting a connector 100 according to an embodiment of the disclosure. FIG. 2 is a view of the front mask 110 shown in FIG. 1 which is taken along a direction indicated by an arrow A.

The front mask 110 is a component molded from a material such as synthetic resin. The front mask 110 has a substantially tubular shape (rectangular tubular shape) which is substantially rectangular in top view and is not uniform in thickness when viewed from a front side which corresponds to a long side of the rectangle.

The front mask 110 has a structure that through-holes 112a and 112b are provided in a main body portion 111 serving as a base. Note that the front mask 110 has a plurality of protrusions and claws that are provided on its side surfaces and back surface (a surface opposite to the front surface) (not shown) and are fitted to a housing 120 (described later) to hold the housing 120. However, they are not related to the subject of the disclosure, and thus illustration and description thereof are omitted.

The main body portion 111 is divided into first regions 111a and 111b and a second region 111c other than the first regions 111a and 111b, the first regions 111a and 111b being located over predetermined distances from both the end portions of the main body portions 111 on the short sides of the rectangle. The main body portion 111 is formed such that the thickness Ta of the main body portion 111 in the first region 111a and the thickness Tb of the main body portion 111 in the first region 111b are larger than the thickness Tc of the main body portion 111 in the second region 111c (Ta>Tc, Tb>Tc). The plate thickness Ta in the first region 111a and the thickness Tb in the first region 111b relative to the plate thickness Tc of the second region 111c, and the width Wa of the first region 111a and the width Wb of the first region 111b can be set as appropriate according to the desired rigidity of the front mask 110. Note that the plate thickness Ta in the first region 111a and the plate thickness Tb in the first region 111b may be the same or different from each other. Furthermore, the width Wa of the first region 111a and the width Wb of the first region 111b may be the same or different from each other.

The through-holes 112a and 112b are holes which penetrate through the main body portion 111 and into which male terminals of a mating connector (not shown) are inserted when the mating connector and the connector 100 are fitted to each other. The through-holes 112a and 112b are provided at positions corresponding to a plurality of male terminals of the mating connector, respectively.

### (2) Housing

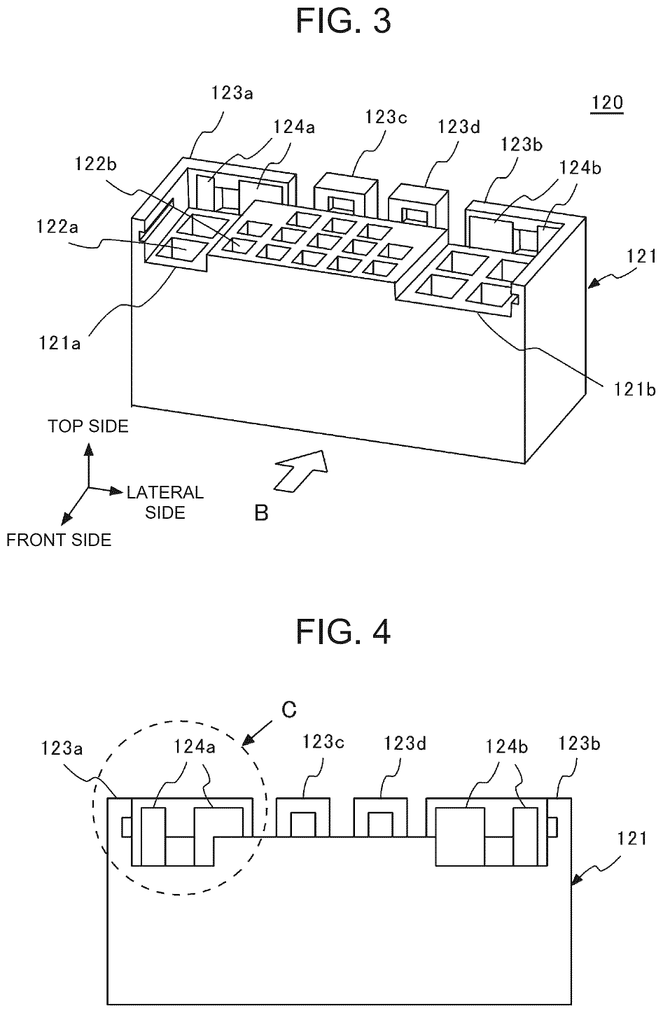

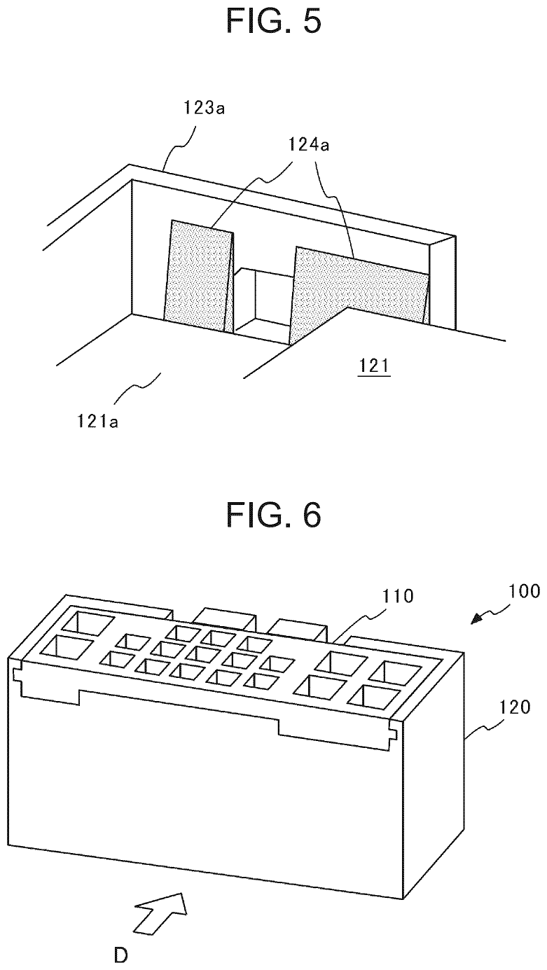

FIG. 3 is a perspective view of the housing 120 constituting the connector 100 according to one embodiment of the disclosure. FIG. 4 is a view of the housing 120 shown in FIG. 3 which is taken along a direction indicated by an arrow B. FIG. 5 is an enlarged perspective view of a portion C in the housing 120 shown in FIG. 4.

The housing 120 is a component which is molded from a material such as synthetic resin or the like. The housing 120 has a rectangular parallelepiped shape that is substantially rectangular in top view.

The housing 120 has a structure that through-holes 122a and 122b and fitting portions 123a, 123b, 123c, and 123d are provided on a main body portion 121 serving as a base.

The main body portion 121 is provided with cutout portions 121a and 121b corresponding to the first regions 111a and 111b of the front mask 110 which are required to fit the front mask 110 to the fitting portions 123a, 123b, 123c and 123d. The depths and widths of the cutout portions 121a and 121b are appropriately set based on the thickness Ta and width Wa of the first region 111a and the thickness Tb and width Wb of the first region 111b.

The through-holes 122a and 122b are holes which penetrate the main body portion 121 and into which a plurality of male terminals of a mating connector (not shown) are inserted through the front mask 110 when the mating connector and the connector 100 are fitted to each other by inserting the front surface of the housing into the opening portion of the mating connector. The through-holes 122a and 122b are respectively provided at positions corresponding to the male terminals of the mating connector like the front mask 110. Furthermore, the through-holes 122a and 122b also have a structure (not shown) that female terminals to be connected to the male terminals of the mating connector to achieve electrical conductivity can be mounted inside the holes.

The fitting portions 123a, 123b, 123c, and 123d are configurations that are formed so as to protrude from the main body portion 121 and position and fix the front mask 110 fitted to the housing 120. Tapered reinforcing portions 124a and 124b are respectively formed on the fitting portions 123a and 123b out of the fitting portions 123a, 123b, 123c and 123d, the fitting portions 123a and 123b being located at positions where the cutout portions 121a and 121b are provided. FIG. 5 shows an example of the reinforcing portion 124a formed on the fitting portion 123a. The reinforcing portion 124a is provided to compensate for the reduction in strength caused by the increased protrusion amount of the fitting portion 123a from the main body portion 121 which is caused by the cutout portion 121a. The reinforcing portion 124b formed on the fitting portion 123b is also provided for the same reason. It is desirable that reinforcing portions 124a and 124b are provided at deformation starting points. Note that with respect to holes, grooves, etc. that are provided inside the fitting portions 123a, 123b, 123c, and 123d and correspond to the protrusions, the claws, etc. provided on the front mask 110, illustrations and description thereon are omitted because these components are not related to the subject of the disclosure.

### Fitting Structure

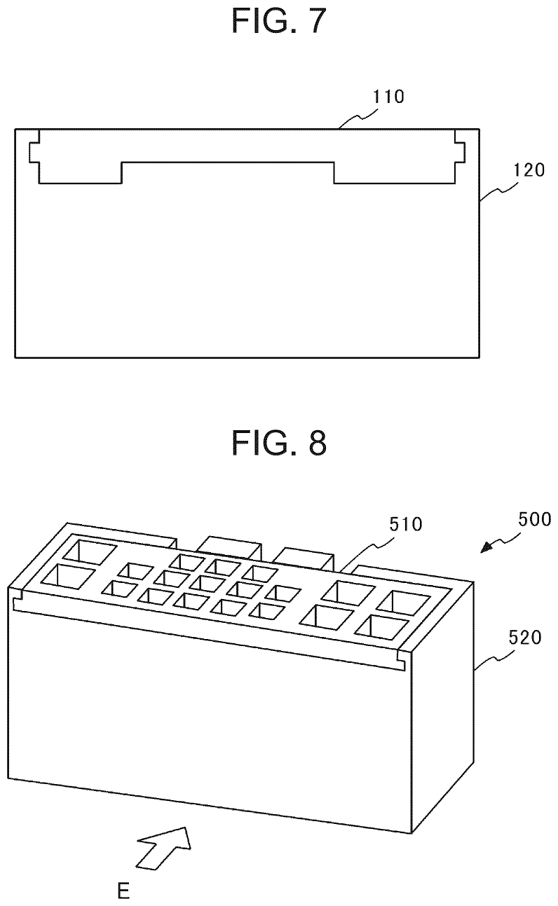

FIG. 6 is a perspective view of the connector 100 according to one embodiment of the disclosure when the front mask 110 and the housing 120 are fitted to each other. FIG. 7 is a view of the connector 100 shown in FIG. 6 which is taken along a direction indicated by an arrow D.

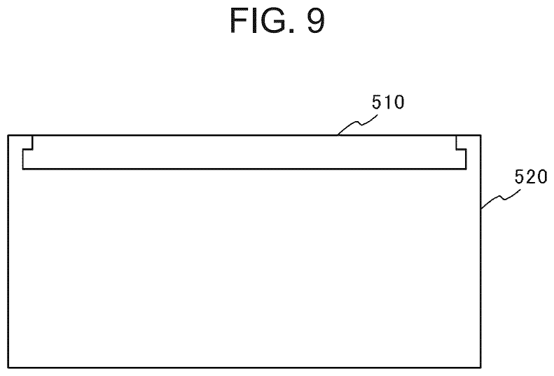

As shown in FIG. 6 and FIG. 7, in the connector 100 according to the present embodiment, the thickness of the front mask 110 is larger at both the end portions (the first regions 111a and 111b) than that at the center portion (the second region 111c). This structure enhances the rigidity of the front mask 110 as compared with a front mask 510 of a connector 500 having a conventional structure shown in FIG. 8 and FIG. 9, which enhances resistance to force of pushing out the front mask 110 and force of deforming the front mask 110 which are caused by external force applied through the terminals of the mating connector in a state where the mating connector are the connector 100 are fitted to each other as compared with the connector 500 having the conventional structure.

### Action and Effect

As described above, according to the connector 100 of one embodiment of the disclosure, the rigidity of the front mask 110 is enhanced by increasing the thickness of the resin at both the end portions (in the width direction) of the front mask 110. Furthermore, the shapes of the fitting portions 123a and 123b of the housing 120 are changed in accordance with the change in the thickness of the front mask 110. In order to cope with reduction in strength of changed portions which may be caused by the change of the shapes of the fitting portions 123a and 123b, a structure that a new taper is provided at a deformation starting point to disperse stress is provided.

This structure makes it possible to restrain positional displacement, deformation, a floating amount, etc. of the front mask 110 after the insertion of the terminals of the mating connector without increasing the external size of the connector 100 or increasing the number of parts. Therefore, a gap is less likely to occur between the front mask 110 and the housing 120, so that it is possible to reduce the possibility that foreign matter enters through the gap.

The structure of the disclosure can be used for a connector having a front mask.

What is claimed is:

1. A connector that is allowed to be fitted to a mating connector, comprising:
a housing configured to be fitted to the mating connector through insertion of a front surface of the housing into an opening portion of the mating connector; and
a rectangular and tabular front mask that has a hole through which a terminal of the mating connector is inserted, and is attached to the front surface of the housing, wherein plate thicknesses at first regions of the front mask on short sides of the rectangle are larger than a plate thickness at a second region other than the first regions of the front mask.

2. The connector according to claim 1, wherein the housing is provided with a taper at a portion to which the respective first region of the front mask is fitted.
